(19) United States
(12) Patent Application Publication
(10) Pub. No.: US 2004/0156950 A1
(43) Pub. Date: Aug. 12, 2004

(54) Use of hop components in foods

(76) Inventors: Martin Richard Green, Bedford (GB); Mark Richards, Rusholme (GB); Maria Catherine Tasker, Bedford (GB)

Correspondence Address: UNILEVER, PATENT DEPARTMENT, 45 RIVER ROAD, EDGEWATER, NJ, 07020, US

(21) Appl. No.: 10/473,985

(22) PCT Filed: Apr. 24, 2002
(86) PCT No.: PCT/EP02/03412

(30) Foreign Application Priority Data
Apr. 5, 2001 (EP) 01303218.0

(51) Int. Cl. C12G 1/00

(52) U.S. Cl. 426/15

(57) ABSTRACT

The invention provides food products with anti-inflammatory and/or anti-ageing properties prepared by incorporating therein an effective amount of isoxanthohumol and/or xanthohumol. Isoxanthouhumol is especially preferred. Also provided is a method of administering isoxanthohumol and/or xanthohumol to persons in need of the intake of an anti-inflammatory and/or anti-ageing component. Food products provided include spreads, dressings, mayonnaises, ice creams, cream alternatives, health bars, health drinks, sports drinks, chocolates, confectionery, bakery products, soups, cereals, sauces, fillings and coatings.

### FIELD OF THE INVENTION

The present invention relates to foods with anti-inflammatory properties and/or with anti-ageing properties.

### BACKGROUND OF THE INVENTION

Prenylated flavones such as xanthohumol or isoxanthohumol are well known compounds which are present in a number of natural products such as hop (see J Agric Food Chem 1999, 47, 2421). Isoxanthohumol and xanthohumol may also be formed during the fermentation of hop and are thus present in fermented hop products. The structure of isoxanthohumol is 5-methoxy, 7-hydroxy, 8-prenyl, 4′-hydroxy flavonone and the structure of xanthohumol is 3′-prenyl-6′-O-methylchalconnaringenin.

The Journal of Chromatography A, Elsevier Science, NL, vol 832 (199) pages 97-107, discloses a HPLC tandem mass spectrometry method for the quantification of several prenylflavonoids in hops and beer e.g. xanthohumol, isoxanthohumol and 8-prenylnaringenin.

WO 01/08652 (Unilever PLC) discloses topical or cosmetic compositions for treating wrinkles and smoothing sensitive skin and comprising conjugated linoleic acid and phenolic compounds such as naringenin.

Although anti-cancer benefits have been attributed to hop components xanthohumol and other prenylated flavonoids, to date, no health benefits have been disclosed for isoxanthohumol. Furthermore, neither anti-inflammatory or anti-ageing properties have been disclosed for xanthouhumol.

There is now emerging an increasing desire for food products to provide more than simply a pleasing taste, or, basic nutritional value to the consumer of the product. Both consumers and the food industry are starting to seek additional benefits from their food products in order to improve, or maintain, the general health and well-being of people consuming such food products.

By “nutritional value” is meant the vitamin and mineral content of the food product. This is sometimes referred to in the art as the micro-nutrient value of the food product. Additional benefits which are now being sought from food products include amongst others, anti-inflammatory benefits and anti-ageing benefits. Such foods are sometimes termed “functional foods”.

A further problem is that such food products do not always have acceptable physical parameters or characteristics such as stability (antioxidant properties), improved taste (intrinsic flavour) and improved physical structure (cross-linking). This can be a problem especially for food products which comprise an appreciable amount of fat.

Accordingly, there is a need in the art to provide food products which provide benefits to improve, or maintain, the general health and well-being of a person regularly consuming such a food product. Such food products desirably also have a pleasing taste and/or are nutritious.

Furthermore, there is also a need to provide food products which have good physical parameters or characteristics such as those mentioned hereinabove.

The present invention seeks to address one or more of the above problems.

### SUMMARY OF THE INVENTION

We have surprisingly found that isoxanthohumol and xanthohumol have anti-inflammatory and anti-ageing effects upon the human body, in particular upon the skin which can result in improved appearance thereof, and can be included in food products to provide these benefits to the consumer thereof.

Without wishing to be bound by theory, it is believed that these effects occur due to isoxanthohumol and xanthohumol promoting procollagen-1 production and reducing PGE2 production in the body.

Furthermore we also have found that isoxanthohumol and/or xanthohumol can be used to achieve beneficial effects upon a number of physical parameters or characteristics of food products, especially, those which contain an appreciable amount of fat. These beneficial effects concern in particular improved stability (antioxidant properties), improved taste (intrinsic flavour) and improved physical structure (cross-linking).

The present invention therefore provides, according to a first aspect, the use of isoxanthohumol and/or xanthohumol in the production of a food product with anti-inflammatory properties, or, with anti-ageing properties.

Especially, the present invention provides the use of isoxanthohumol in the production of a food product.

The food product may have both anti-inflammatory properties and anti-ageing properties.

According to a second aspect, the present invention provides a method for administering isoxanthohumol and/or xanthohumol to humans in need of the intake of an anti-inflammatory or an anti-ageing component, wherein the human is administered an effective daily amount of isoxanthohumol and/or xanthohumol by feeding this human with a food product comprising of from 10 to 100 or 200 wt % of the recommended daily amount of isoxanthohumol and/or xanthohumol.

The “effective daily amount” administered to the human in need of the intake of an anti-inflammatory or an anti-ageing component is that amount which results in a noticeable improvement of the defect in question.

The “recommended daily amount” (RDA) is an amount in the range of from 0.5 μg, especially 50 μg to 100 mg per day. Lower amounts within this RDA can also be used for example 0.5 μg to 2000 μg.

Where a mixture of isoxanthohumol and xanthohumol is used, the amounts referred to herein refer to the amount of that mixture.

The level of isoxanthohumol and/or xanthohumol administered may be in the range of from 0.5 μg to 200 μg. However higher levels such as 50 μg to 100 mg, such as 100 μg to 50 mg, for example 500 μg to 10 mg per serving of the food product may also be used if it is desired to provide a higher dosage of isoxanthohumol and/or xanthohumol.

According to a third aspect, the present invention provides a food-product selected from the group consisting of: spreads, dressings, mayonnaises, ice creams, cream alternatives, health bars, health drinks, sport drinks, chocolates, confectionery, bakery products, soups, cereals, sauces, fillings and coatings, and comprising an effective amount of isoxanthohumol and/or xanthohumol, to enable a person ingesting a daily portion of the food-product to thereby receive an amount of from 10 to 100 or 200% of their recommended daily amount of isoxanthohumol and/or xanthohumol.

A daily portion of the food product is that amount which is typically consumed in a day for the type of food product in question. It may be consumed in more than one sitting but is ideally consumed in one (a single daily portion) or two sittings.

Isoxanthohumol and xanthohumol, especially isoxanthouhumol, derived from hop have been found to be especially suitable according to all aspects of the present invention.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

### DETAILED DESCRIPTION OF THE INVENTION

The invention will now be discussed in greater detail. The level of isoxanthohumol and/or xanthohumol used in the food product can vary considerably. However, it is demonstrated that levels sufficient to provide of from 10 to 100 or 200 wt %, for example 20 to 95 wt %, of the recommended daily amount (RDA) of isoxanthohumol and/or xanthohumol upon consuming a daily portion of the food product can easily be used according to the invention.

Typically the isoxanthohumol and/or xanthohumol is used at a level sufficient to provide of from 0.01 to 95 wt % in the food product (by weight of the food product), preferably of from 0.5 to 35 wt %, more preferably of from 0.8 to 10 wt %. For some food products lower levels within these ranges may be preferred, such as 0.02 to 5 wt %, preferably 0.05 to 2.5 wt %.

The isoxanthohumol and/or xanthohumol can be added to, and incorporated in, the food product in any suitable form including; as a free compound, as a concentrate or an extract of a natural product (in particular as a concentrate or extract of hop, e.g. polyphenol hop extract available ex Botanix Ltd, UK), in encapsulated form (in particular encapsulated by a sugar, a starch or gelatin), or, as isoxanthohumol an/or xanthohumol powder or crystals. If a powder or crystals are used it is preferably used on a carrier.

The isoxanthohumol and/or xanthohumol may be added to the food product (or components thereof) by any suitable method known in the art, for example by mixing with a blade mixer or other known food mixers.

The isoxanthohumol and/or xanthohumol may be incorporated into many types of food products. Typical examples include spreads, dressings, mayonnaises, ice creams, cream alternatives, health bars, health drinks, sports drinks, chocolates, confectionery, bakery products, soups, cereals, sauces, fillings and coatings.

According to the second aspect of the invention, the actual amount of isoxanthohumol and/or xanthohumol administered will depend upon the type of food product and the delivery form used. The isoxanthohumol and/or xanthohumol may administered by eating one or more food products or portions thereof.

Moreover it is believed that isoxanthohumol and/or xanthohumol can also be used to synergistically enhance the anti-inflammatory or anti-ageing effects of other natural anti-inflammatory or anti-ageing components in food products. For example, combinations of isoxanthohumol and/or xanthohumol with other isoflavones or with other flavones may demonstrate such a synergistic anti-inflammatory or anti-ageing effect. Such other isoflavones or other flavones may be used in the food product in any suitable amount.

Isoxanthohumol and/or xanthohumol may also be used in combination with other micronutrients, for example, vitamins such as vitamin C and vitamin E.

As indicated above, isoxanthohumol and/or xanthohumol may also have a beneficial effect on the physical performance /characteristics of food products. In particular their use in food products, especially in the amounts mentioned above, can result in improvements in stability (antioxidant properties), taste (intrinsic flavour) and physical structure (cross-linking) of the food product.

The present invention will be further explained with reference to the following examples.

### EXAMPLES

### Example 1

### Anti-inflammatory effects; Procedure for Measuring PGE2 Levels in Human Dermal Fibroblasts

Anti-inflammatory Cell Assays.

It is emphasized that the anti-inflammatory effects were determined by in vitro tests wherein the Prostaglandin E2 (=PGE2) production by the human skin fibroblasts is measured after being induced by the inflammatory modulus phorbyl myristate acetate (PMA). A reduction of the levels of PGE2 is indicative of the anti-inflammatory effect. Fibroblast cell assay Primary human foreskin fibroblasts at passage 2 (P2) were seeded into 96-well plates at 35000 cells/well and maintained for 24 hours in an atmosphere of 5% carbon dioxide in Dulbeccos Modified Eagles Medium (DMEM) supplemented with 10% foetal calf serum.

Isoxanthohumol was added to fresh cell media (DMEM, supplemented with 10% foetal calf serum) in 100% ethanol (final concentration 1%) in triplicate and incubated for a further 24 hours. Phorbal myristate acetate (PMA) in ethanol/cell media (10 nm) was added to the cells treated with isoxanthohumol and the cells incubated for a further 24 hours. PMA represents an external stressor, which induces oxidative stress and inflammatory responses in cells. The fibroblasts/media were then analysed as described below immediately, or, snap frozen in liquid nitrogen and stored at −70° C. for future analysis. The cells were then counted to ensure no effect on cell number.

Different concentrations of isoxanthohumol were used in the above method to study the effect of concentration. A series of control experiments were also carried out according to the above method; Control+veh+PMA (positive control), Control+veh (negative control) and control (standard control).

Prostaglandin E2 (PGE2) assay volumes of 50 μl culture medium were taken for PGE2 assay from the above samples after gently shaking the culture plate. PGE2 levels in the medium were determined with a Biotrak PGE2 immunoassay kit (Amersham, UK). The assay is based on the competition between unlabelled PGE2 in the sample and a fixed quantity of horseradish peroxidase labelled PGE2 for a limited amount of fixed PGE2 specific antibody. Concentrations of unlabelled sample PGE2 are determined according to a standard curve, which was obtained at the same time.

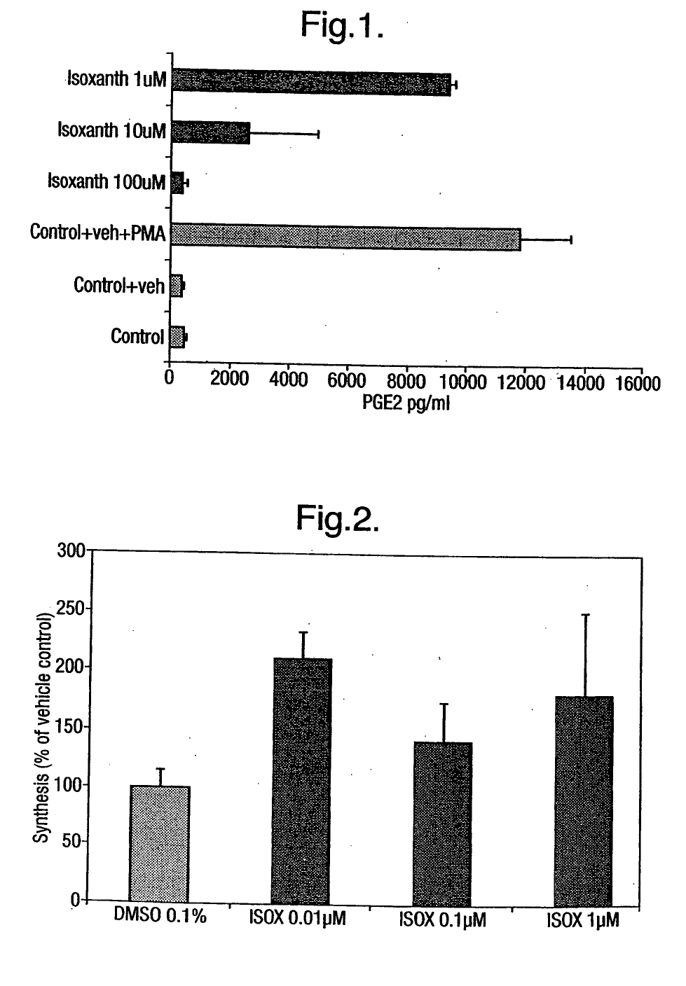

The results of the administering of different amounts of isoxanthohumol are illustrated in FIG. 1. “Isoxanth” refers to the isoxanthohmuol-containing samples which contained the stated levels of isoxanthohumol. The results show that isoxanthohumol is effective in producing an anti-inflammatory effect in human cells as can be seen by comparing the result for the control+veh+PMA with the results obtained for the three different levels of Isoxanthohumol. Increasing concentrations of isoxanthoumumol produced increasing anti-inflammatory effects as measured by a reduction in PGE2.

The above methodology can be repeated using xanthohumol or mixtures of isoxanthohumol and xanthouhumol.

### Example 2

### Anti-Ageing Effects; Procedure for Measuring Procollagen-I Synthesis in Human Dermal Fibroblasts

Anti-Ageing Cell Assays; Preparation of Dermal Fibroblast Conditioned Medium.

It is emphasized that the anti-ageing effects were determined by in vitro tests wherein the Procollagen-I production by the human dermal fibroblasts is measured after being induced by the anti-ageing stimulus. An increase in the levels of Procollagen-I is indicative of the anti-ageing effect.

Primary human foreskin fibroblasts at passage 2 (P2) were seeded into 12-well plates at 40000 cells/well and maintained for 24 hours in an atmosphere of 5% carbon dioxide and 4% oxygen in Dulbeccos Modified Eagles Medium (DMEM) supplemented with 10% foetal calf serum. After this time the cells were washed with serum free DMEM and then incubated in fresh serum free DMEM for a further 60 hours. The fibroblast monolayers were then washed again with serum free DMEM.

Test reagent (Isoxanthohumol at different concentration levels) and vehicle control (0.1% DMSO final concentration) were added to the cells in triplicate in a final volume of 0.4 ml/well fresh serum free DMEM and incubated for a further 24 hours. This fibroblast conditioned medium was either analysed immediately, or, snap frozen in liquid nitrogen and stored at −70° C. for future analysis. The cells were then counted and data from the dot-blot analysis subsequently standardised to cell number.

The results of the administering of different amounts of isoxanthohumol are illustrated in FIG. 2. These results show that the isoxanthohumol samples showed increased anti-ageing effects in human cells compared to a control sample.

The above methodology can be repeated using xanthohumol or mixtures of isoxanthohumol and xanthouhumol.

### Example 3

### Anti-Inflammatory Effects

The methodology described above for example 1 was repeated for example 3, but a polyphenol hop extract comprising 3% wt isoxanthohumol (available from Botanix Ltd, UK) was used as the isoxanthohumol source. The amount of isoxanthohumol in the three samples tested invention was; 0.3 ug/ml isoxanthohumol in the Botanix 10 ug/ml, 3 ug/ml isoxanthohumol in the Botanix 100 ug/ml and 30 ug/ml isoxanthohumol in the Botanix 1 mg/ml.

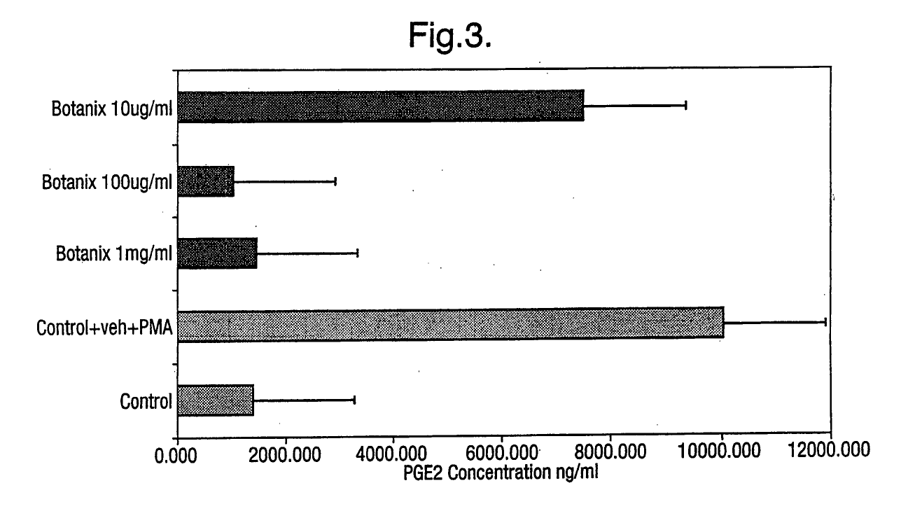

The results of the administering of different amounts of this polyphenol hops extract are illustrated in FIG. 3. “Botanix” refers to the polyphenol hops extract as supplied ex Botanix Ltd. These results show that the hop extract comprising isoxanthohumol is effective in producing an anti-inflammatory effect in human cells as can be seen by comparing the result for the control+veh+PMA with the results obtained for the three different levels of the Botanix extract. Increasing concentrations of the hop extract produced increasing anti-inflammatory effects.

### Example 4

An ice cream can be prepared according to the following recipe;

| | Wt % |
|---|---|
| Isoxanthohumuol | 0.02 |
| Fat blend | 10.0 |
| Skimmed milk powder | 10.0 |
| Icing sugar | 12.0 |
| Corn syrup solids | 4.0 |
| Dextrose monohydrate | 2.0 |
| Sherex IC 93300 | 0.6 |
| Water to balance of | 100.0 |

Sherex IC 93300 is a product comprising mono- and diglycerides mixed with different stabilizers from Quest International.

Mix the ingredients except the water and the fat blend. Add the water (cold) to this mixture and then heat in a water bath to a temperature of 70° C. Add the fat blend (fully liquid palm oil) whilst the mixture is ‘stirred’ in a high speed mixer e.g. an Ultra-turax mixer to form an emulsion. Cool the mixture in a water bath to 20° C. and then stir again e.g. in the ultra-turrax. Place the emulsion in a batch ice cream making machine (held for 24 hours at −28° C. prior to use) and stir for 15 minutes.

An ice cream of good quality is obtained. The manufacture of the ice cream of example 4 can be repeated using xanthohumol instead of isoxanthohumol or mixtures of xanthohumol and isoxanthohumol.

### Example 5

A spread containing isoxanthohumol may be prepared from the following ingredients using the process below:

| | wt % |
|---|---|
| Isoxanthohumol | 5 × 10⁻³ |
| Oil blend | 49.5 |
| Lecithin | 0.205 |
| distilled monoglyceride | 0.3 |
| Flavour | 0.01 |
| Colour | 0.0066 |
| Whey | 0.25 |
| EDTA | 0.007 |
| Citric Acid | 0.03 |
| K Sorbate | 0.1 |
| Salt | 1.6 |
| Water to balance of | 100.0% |

Mix the fat and aqueous phases together at approximately 55° C. in a heated tank in a ratio of approximately 40 parts fat phase to 60 parts aqueous phase to produce a fat continuous emulsion. The aqueous phase is added to the fat phase to aid in obtaining a fat continuous emulsion.

Pass the emulsion through a cooled, scraped-surface heat exchanger (A-unit) where the emulsion is cooled to a temperature at which the fat will begin to crystallize (about 8-20° C.) and the aqueous phase will begin to increase in viscosity. Pass the cooled emulsion through a C-unit, crystallizer; the shaft speed may vary and depends upon it's dimensions and the residence time required to crystallize the fat. Typical speeds are in the range of from 100-900 RPM. Pass the fat continuous emulsion into an additional cooling unit to reduce the temperature of the emulsion as there is a temperature rise due to heat of crystallization in the crystallizer. For a tub packaged product, the cooled emulsion is passed through the crystallizer (C-Unit) to provide additional residence time and adjust the consistency for packaging in tub. For a stick or bar product, pass the cooled emulsion through a B-Unit for additional residence time and to increase the packing hardness for the product to be packed in the stick or bar form.

A spread of good quality is obtained. The manufacture of the spread of example 4 can be repeated using xanthohumol instead of isoxanthohumol or xanthohumol and isoxanthohumol.

1. The use of isoxanthohumol and/or xanthohumol in the production of a food product with anti-inflammatory properties, or, with anti-ageing properties.

2. The use according to claim 1 wherein isoxanthohumol is used in the production of a food product.

3. The use according to either claim 1 or claim 2 wherein the isoxanthohumol and/or xanthohumol are used at a level sufficient to provide of from 10 to 200 wt % of the recommended daily amount of isoxanthohumol and/or xanthohumol upon consumption of a daily portion of the food product.

4. The use according to claim 3 wherein the isoxanthohumol and/or xanthohumol are used at a level sufficient to provide of from 10 to 100 wt % of the recommended daily amount.

5. The use according to any one of claims 1 to 4 wherein the isoxanthohumol and/or xanthohumol are used in the production of a food product at a level sufficient to provide of from 0.01 to 95 wt % isoxanthohumol and/or xanthohumol in the food product by weight thereof.

6. The use according to claim 5 wherein the isoxanthohumol and/or xanthohumol is used at a level sufficient to provide of from 0.02 to 5 wt % isoxanthohumol and/or xanthohumol in the food product by weight of the food product.

7. The use according to any one of claims 1 to 6 wherein the food product is selected from the group consisting of: spreads, dressings, mayonnaises, ice creams, cream alternatives, health bars, health drinks, sports drinks, chocolates, confectionery, bakery products, soups, cereals, sauces, fillings and coatings.

8. The use according to any one of claims 1 to 7 wherein the isoxanthohumol and/or xanthohumol are used to achieve stabilisation, and/or improved taste, and/or improved physical structure of the food product.

9. The use according to any one of claims 1 to 8 wherein the isoxanthohumol and/or xanthohumol are incorporated in the food product as a free compound, as a concentrate or an extract of a natural product, in encapsulated form, or, as a powder or crystals of isoxanthohumol and/or xanthohumol on a carrier.

10. The use according to claim 9 wherein the concentrate or extract of a natural product is a hop concentrate or hop extract.

11. The use according to claim 9 wherein the isoxanthohumol and/or xanthohumol in encapsulated form are encapsulated in a sugar, a starch or gelatin.

12. A method for administering isoxanthohumol and/or xanthohumol to humans in need of the intake of an anti-inflammatory or an anti-ageing component, wherein the human is administered an effective daily amount of isoxanthohumol and/or xanthohumol by feeding this human with a food product comprising of from 10 to 200 wt % of the recommended daily amount of isoxanthohumol and/or xanthohumol.

13. The method according to claim 12 wherein the human is fed with a food product comprising of from 10 to 100 wt % of the recommended daily amount of isoxanthohumol and/or xanthohumol.

14. The method according to claim 13 wherein isoxanthohumol is administered to the human.

15. The method according to either claim 12 or 13 wherein the isoxanthohumol and/or xanthohumol are derived from hop.

16. The method according to any one of claims 12 to 15 wherein the food product is selected from the group consisting of: spreads, dressings, mayonnaises, ice creams, cream alternatives, health bars, health drinks, sports drinks, chocolates, confectionery, bakery products, soups, cereals, sauces, fillings and coatings.

17. The method according to any one of claims 12 to 16 wherein the food product comprises of from 0.01 to 95 wt % of isoxanthohumol and/or xanthohumol, based on the weight of the food product.

18. The method according to claim 17 wherein the food product comprises 0.02 to 5 wt % of isoxanthohumol and/or xanthohumol, based on the weight of the food product.

19. A food-product selected from the group consisting of: spreads, dressings, mayonnaises, ice creams, cream alternatives, health bars, health drinks, sport drinks, chocolates, confectionery, bakery products, soups, cereals, sauces, fillings and coatings, and comprising an effective amount of isoxanthohumol and/or xanthohumol to enable a person ingesting a daily portion of the food-product to thereby receive an amount of from 10 to 200 wt % of their recommended daily amount of isoxanthohumol and/or xanthohumol.

20. The food-product according to claim 19 comprising an effective amount of isoxanthohumol and/or xanthohumol to enable a person ingesting a daily portion of the food-product to thereby receive an amount of from 10 to 100 wt % of their recommended daily amount of isoxanthohumol and/or xanthohumol.

21. The food-product according to claim 20 comprising an effective amount of isoxanthohumol.
